(19) United States
(12) Patent Application Publication
(10) Pub. No.: US 2025/0133551 A1
(43) Pub. Date: Apr. 24, 2025

(54) CHANNEL SELECTION METHODS FOR MULTIPLE PRIMARY CHANNELS

(71) Applicant: QUALCOMM Incorporated, San Diego, CA (US)

(72) Inventors: Gaurang NAIK, San Diego, CA (US); Yanjun SUN, San Diego, CA (US); Abhishek Pramod PATIL, San Diego, CA (US); George CHERIAN, San Diego, CA (US); Alfred ASTERJADHI, San Diego, CA (US); Sai Yiu Duncan HO, San Diego, CA (US); Abdel Karim AJAMI, San Diego, CA (US)

(21) Appl. No.: 18/888,555

(22) Filed: Sep. 18, 2024

Related U.S. Application Data
(60) Provisional application No. 63/592,289, filed on Oct. 23, 2023.

(51) Int. Cl. H04W 72/0453

(52) U.S. Cl. CPC H04W 72/0453

(57) ABSTRACT

This disclosure provides methods, components, devices and systems that may help various wireless devices that select multiple primary channels, for a basic service set (BSS), to contend for channel access. An example method, performed at a first wireless node (e.g., an access point), generally includes obtaining, via a first primary channel, a frame indicating a first configuration of a first basic service set (BSS), and communicating, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

### CROSS-REFERENCE TO RELATED APPLICATION(S)

This application claims the benefit of and priority to U.S. Provisional Application No. 63/592,289, filed Oct. 23, 2023, which is assigned to the assignee hereof and hereby expressly incorporated by reference in its entirety as if fully set forth below and for all applicable purposes.

### TECHNICAL FIELD

This disclosure relates generally to wireless communication, and more specifically, to aspects related to selecting bandwidth configurations for networks that support multiple channels to contend for access to a wireless medium.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLAN scenarios, devices share access to a wireless medium. In such scenarios, contention-based channel access is a mechanism used to share the wireless medium. This mechanism allows multiple devices to access the same wireless channel without a centralized coordinator, making it suitable for scenarios with a variable number of devices.

For example, devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

### SUMMARY

The systems, methods and devices of this disclosure each have several innovative aspects, no single one of which is solely responsible for the desirable attributes disclosed herein.

One aspect provides a method for wireless communications, related to selecting bandwidth configurations for networks that support multiple channels to contend for access to a wireless medium. The method generally includes obtaining, via a first primary channel, a frame indicating a first configuration of a first basic service set (BSS) and communicating, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The appended figures depict certain features of the various aspects described herein and are not to be considered limiting of the scope of this disclosure.

FIG. 1 shows a pictorial diagram of an example wireless communication network.

FIG. 2 shows a pictorial diagram of an example bandwidth configuration for a wireless local area network (WLAN).

FIGS. 3A and 3B show an example of primary and secondary channel selection for a given channel.

FIGS. 4 and 5 show examples of channel access using multiple primary channels, in which aspects of the present disclosure may be utilized.

FIGS. 6 and 7 show examples of channel selection rules.

FIG. 8 shows an example call flow diagram for channel selection, in accordance with aspects of the present disclosure.

FIGS. 9-15 show examples of primary and secondary channel selection, in accordance with aspects of the present disclosure.

FIGS. 16 and 17 show examples of channel access using multiple primary channels, in which aspects of the present disclosure may be utilized.

FIG. 18 shows a flowchart illustrating an example process performable at an access point (AP) that supports channel selection related to aspects of the present disclosure.

FIG. 19 shows a block diagram of an example wireless communication device that supports aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to techniques for selecting bandwidth configurations for networks that support multiple channels to contend for access to a wireless medium.

Contention-based channel access generally refers to a mechanism used to share the wireless medium. Devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

Contention-based channel access may be used to share access in WLANs that support relatively large bandwidths. For example, IEEE 802.11be Extremely High Throughput (EHT), also known as Wi-Fi 7, has defined bandwidth support for up to 320 MHz. Within the large bandwidth, one 20 MHz channel is designated as a primary channel.

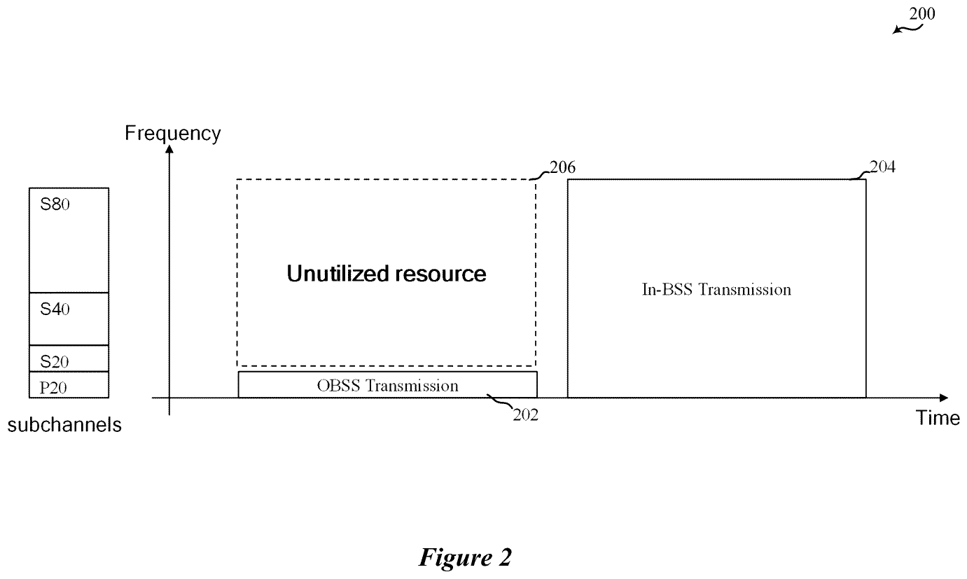

For example, FIG. 2 depicts a diagram 200 for an example bandwidth configuration for a 160 MHz bandwidth, in which the 20 MHz primary channel is labeled P20. A Wi-Fi device contends for access only on the primary channel and access to wider bandwidths (no matter how large) is contingent on access to the primary channel.

Therefore, if an overlapping basic service set (OBSS) STA occupies the primary channel, another (In-BSS) STA may detect an OBSS transmission 202 when performing channel access on the primary channel. Because access to the wider bandwidth (for In-BS transmissions 206) is contingent on access to the primary channel, a remainder of the wide bandwidth 204 remains unutilized, which contributes to lower-throughput and longer latencies.

In some WLAN scenarios, however, a WLAN device may be capable of monitoring additional 20 MHz channel(s) within the operating bandwidth to contend for channel access. Such monitoring may be performed sequentially or in parallel. With sequential monitoring, when one 20 MHz primary channel is found Busy, the device switches to the next 20 MHz channel to contend for access. With parallel monitoring, the device can monitor each 20 MHz channel simultaneously. In such scenarios, the initial primary channel is referred to as a Main Primary (M-Primary) channel, while an additional 20 MHz channel/subchannel is referred to as an Opportunistic Primary (O-Primary) channel.

One potential challenge with multi-primary channel access, is how access points (APs) forming new basic service sets (BSSs) will select the multiple channels used for channel access. Aspects of the present disclosure provide various rules and techniques that may be used for the selection of M-Primary and O-Primary channels.

As will be described in greater detail below, an AP may detect a channel configuration of an existing BSS that is using multi-primary channel access. The techniques disclosed herein may allow the AP to select the operating bandwidth configuration associated with O-Primary channel(s), as well as secondary channels associated with O-Primary channel(s).

Particular aspects of the subject matter described in this disclosure can be implemented to realize one or more of the following potential advantages. In some examples, the described techniques can be used to optimize bandwidth configurations. The techniques disclosed herein allow for bandwidth configurations that may allow multiple STAs to use the same channel for contention, allowing the STAs to detect each other using preamble detection and defer to each other's transmissions. Channel selection performed according to techniques proposed herein may also help mitigate the impact of adjacent channel interference in overlapping BSSs (OBSSs).

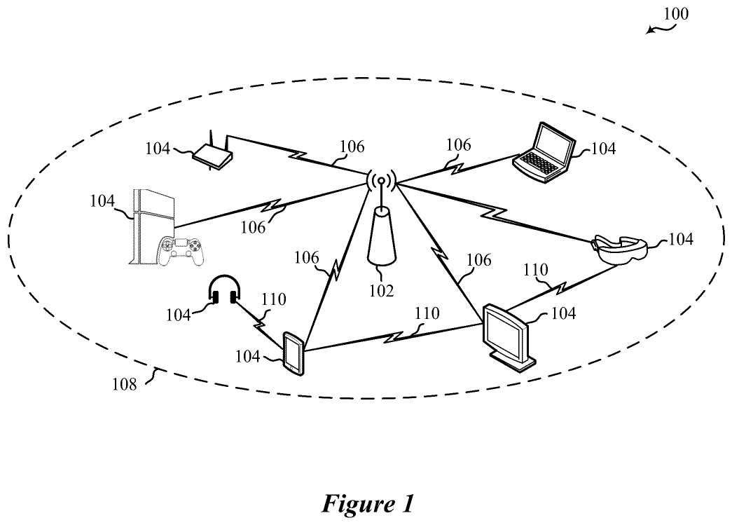

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad-hoc network (or wireless ad-hoc network). Ad-hoc networks may alternatively be referred to as mesh networks or peer-to-peer (P2P) networks. In some cases, ad-hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad-hoc system, one or more of the STAs 104 may assume the role filled by the AP 102 in a BSS. Such a STA 104 may be referred to as a group owner (GO) and may coordinate transmissions within the ad-hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1(410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some examples, the AP 102 or the STAs 104 of the WLAN 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of WLAN 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher increases the likelihood that low-latency data traffic will gain access to a shared wireless medium during a given contention period, unpredictable outcomes of medium access contention operations may prevent low-latency applications from achieving certain levels of throughput or satisfying certain latency requirements.

### Overview of Channel Numbering

A primary channel generally refers to a channel that a STA monitors for contention-based channel access. As described above with reference to FIG. 2, in WLANs that support relatively large bandwidths, one 20 MHz channel is designated as a primary channel. This channel may be referred to as primary 20 or, as labeled in FIG. 2, simply P20.

Selection of the bandwidth for the P20 channel typically decides all other channels. For example, in the case of a 160 MHz operating bandwidth, selection of P20 may determine a secondary 20 MHz channel (S20), a primary 40 MHz channel (P40), a secondary 40 MHz channel (S40), a primary 80 MHz channel (P80), and a secondary 80 MHz channel (S80).

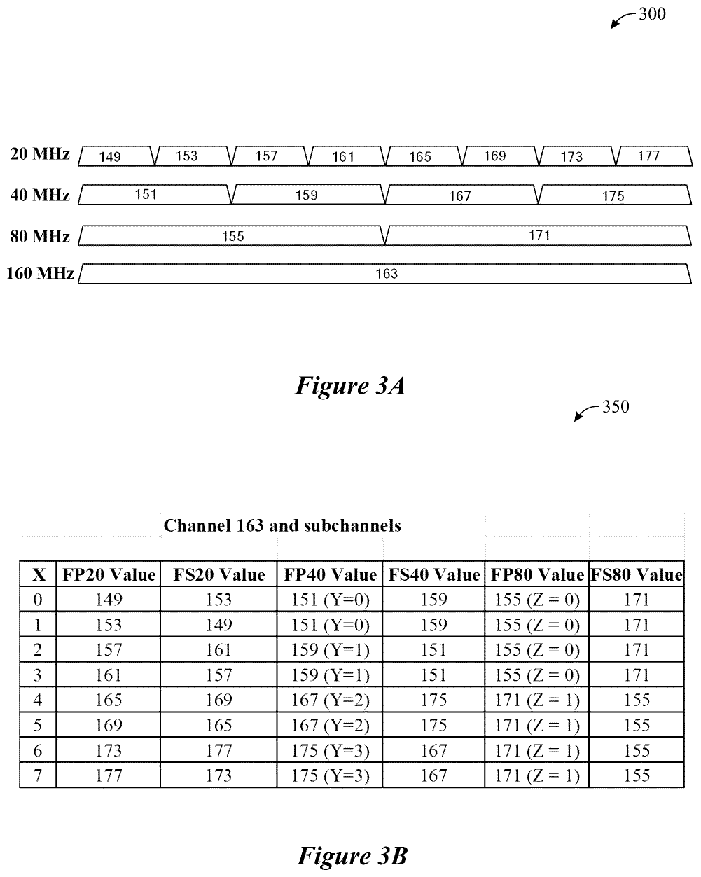

FIGS. 3A and 3B show an example of primary and secondary channel selection for a given channel. Diagram 300 of FIG. 3A shows how the bandwidth of a 160 MHz channel number 163 may be allocated to form different 80 MHz channels (155 and 171), 40 MHz channels (151, 159, 167, and 175), and 20 MHz channels (149, 153, 157, 161, 165, 169, 173, and 177). Particular channel frequencies for these channels may be determined based on a set of equations, determined by the operating bandwidth and a channel selection parameter X.

Table 350 of FIG. 3B shows the possible combinations of channel frequencies for P20, S20, P40, S40, P80, and S80 channels for the 160 MHz bandwidth channel 163 shown in FIG. 3A. As illustrated, selecting the parameter X is essentially the same as choosing the channel frequency for P20. For example, choosing X=1 means P20 is 153 and vice versa, resulting in S20=149, P40=151), S40=159, P80=155, and S80=171.

### Aspects Related to Channel Selection for Multiple Primary Channels

As noted above, in some WLAN scenarios, a STA may be capable of monitoring additional 20 MHz channel(s) within the operating bandwidth to contend for channel access. In such scenarios, the initial primary channel is referred to as a Main Primary (M-Primary or M-P20) channel, while an additional 20 MHz channel/subchannel is referred to as an Opportunistic Primary (O-Primary or O-P20) channel.

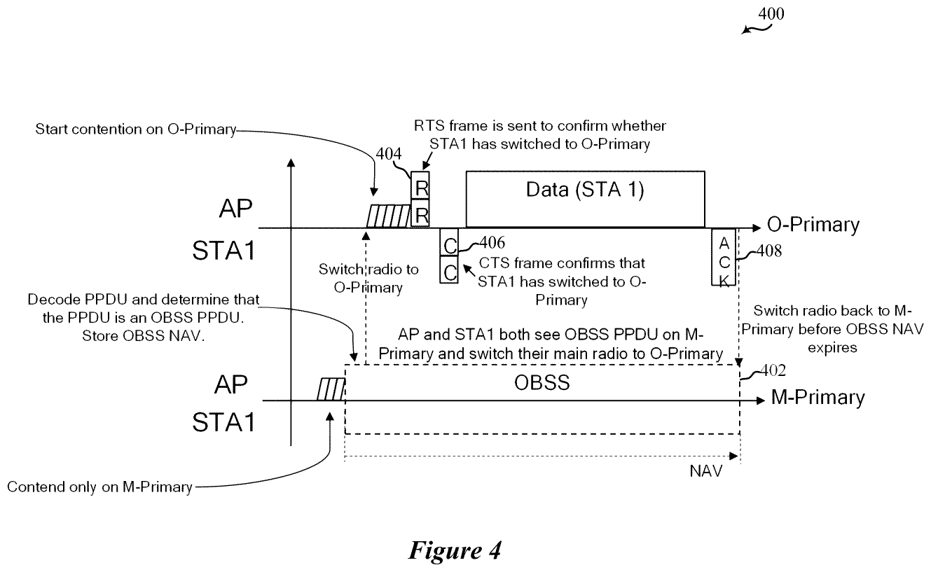

FIG. 4 shows an example diagram 400 of channel access for an AP and a STA (STA1) using sequential monitoring of multiple primary channels. As illustrated, with sequential monitoring, when the M-Primary channel is found Busy (e.g., as indicated by detection of a transmission 402 in an OBSS), the devices may switch to an O-Primary channel to contend for access.

The devices may detect the M-Primary channel is busy by decoding a PPDU and determining that the PPDU is an OBSS PPDU. The devices may also store an OBSS network allocation vector (NAV) indicated by a duration field in the OBSS PPDU, in order to determine when to switch back to the M-Primary channel.

In some cases, the AP may send an RTS frame 404 so that STA1 switches to the O-Primary channel. STA1 may respond with a CTS frame 406 to confirm that STA1 has switched to the O-Primary channel. As illustrated, the devices may switch their main radios back to the M-Primary channel before the OBSS NAV expires (e.g., after a data transmission acknowledged by an ACK 408).

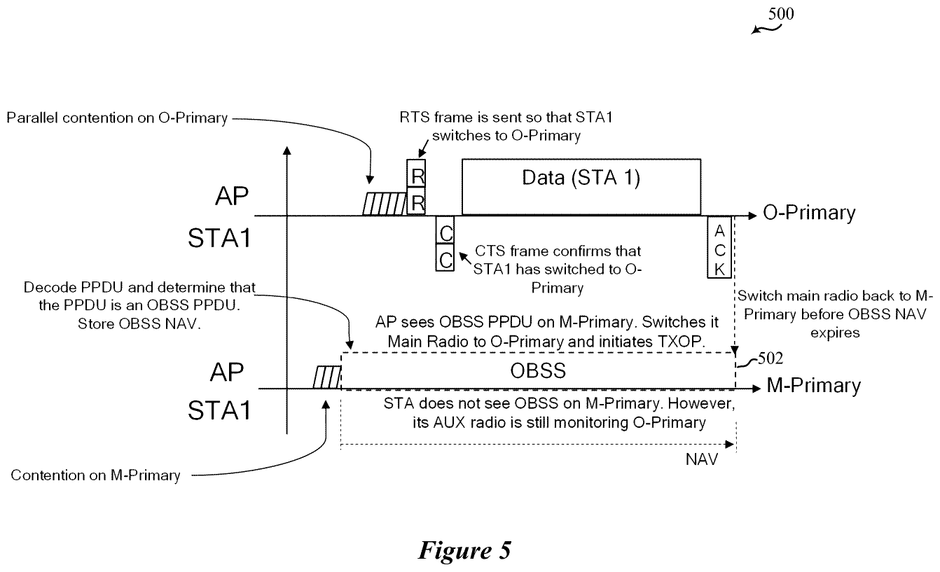

As illustrated in FIG. 5, with parallel monitoring, the device can monitor each 20 MHz channel simultaneously. For example, a STA may have an auxiliary (AUX) radio that can be used for parallel monitoring. In the illustrated example, the AP sees the OBSS PPDU 502 on the M-Primary channel and switches its main radio to the O-Primary channel and initiates a TXOP. While STA1 does not see the OBSS PPDU 502 on the M-Primary channel, it may still monitor the O-Primary channel, via its AUX radio. Therefore, it may detect the RTS frame from the AP and switch to the O-Primary channel accordingly.

One potential challenge with multi-primary channel access is how APs forming new BSSs will select the multiple channels used for channel access. Aspects of the present disclosure provide various rules that may be used for the selection of M-Primary and O-Primary channels.

According to certain aspects of the present disclosure, an AP may detect a channel configuration of an existing BSS that is using multi-primary channel access. The techniques may allow the AP to select the operating bandwidth configuration associated with O-Primary channel(s), as well as secondary channels associated with O-Primary channel(s).

Standard specifications may define certain rules for how Wi-Fi BSSs select their primary channels. For example, a rule may dictate that, before a STA starts a very high throughput (VHT) BSS, the STA should perform OBSS scan operations to search for existing BSSs. Due to the nature of advancing standards releases, a particular STA that is compliant with one standard may be considered as compliant with previous standards. For example, an ultra high reliability (UHR) STA by default will also be an extremely high throughput (EHT) STA, a high efficiency (HE) STA, and a very high throughput (VHT) STA. Thus, a BSS started by a UHR STA may also be considered a VHT BSS.

As another example, a rule may dictate that if an AP or a mesh STA starts a BSS that occupies some or all channels of any existing BSS, the AP or mesh STA may select a primary channel of the new BSS that is identical to the primary channel of any one of the existing BSSs.

As another example, a rule may dictate that if an AP or a mesh STA selects a primary channel for a new BSS with a 40 MHz, 80 MHz, 160 MHz, or 80+80 MHz BSS bandwidth from among the channels on which no beacons are detected during the OBSS scans, then the selected primary channel may be expected to meet various conditions. Such conditions may include, for example, that the selected primary channel: 1) is not be identical to the secondary 20 MHz channel of any existing BSSs with a 40 MHz, 80 MHz, 160 MHz, or 80+80 MHz BSS bandwidth; and 2) is not to overlap with the secondary 40 MHz channel of any existing BSSs with a 80 MHz, 160 MHz or 80+80 MHz BSS bandwidth.

As another example, a rule may dictate that a STA that is an AP or mesh STA should not start a BSS with a 20 MHz BSS bandwidth on a channel that is the secondary 20 MHz channel of any existing BSSs with a 40 MHz, 80 MHz, 160 MHz, or 80+80 MHz BSS bandwidth, or is overlapped with the secondary 40 MHz channel of any existing BSSs with a 160 MHz or 80+80 MHz BSS bandwidth.

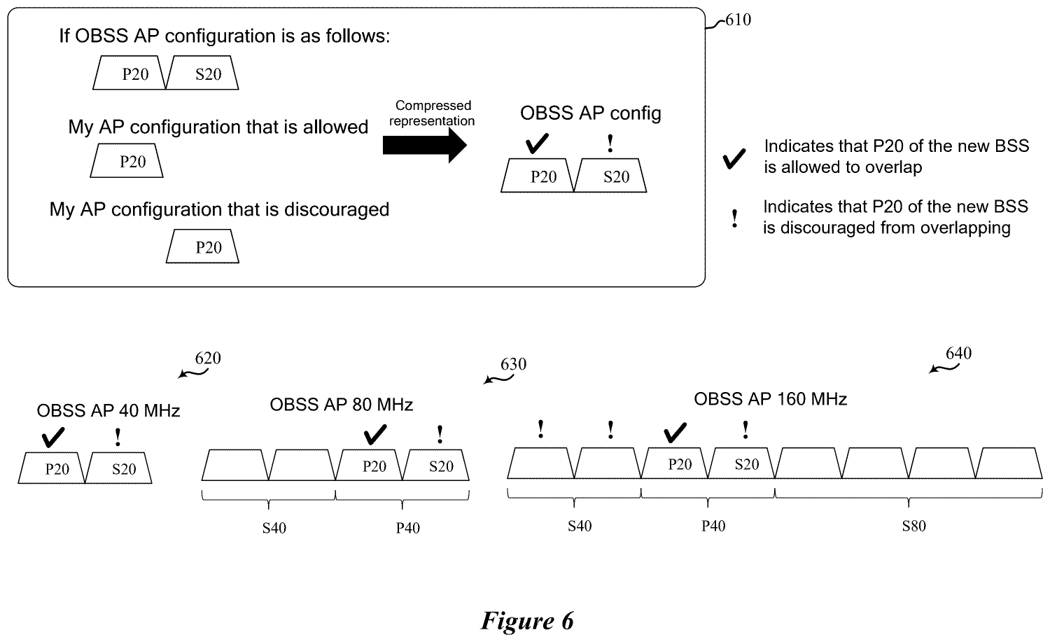

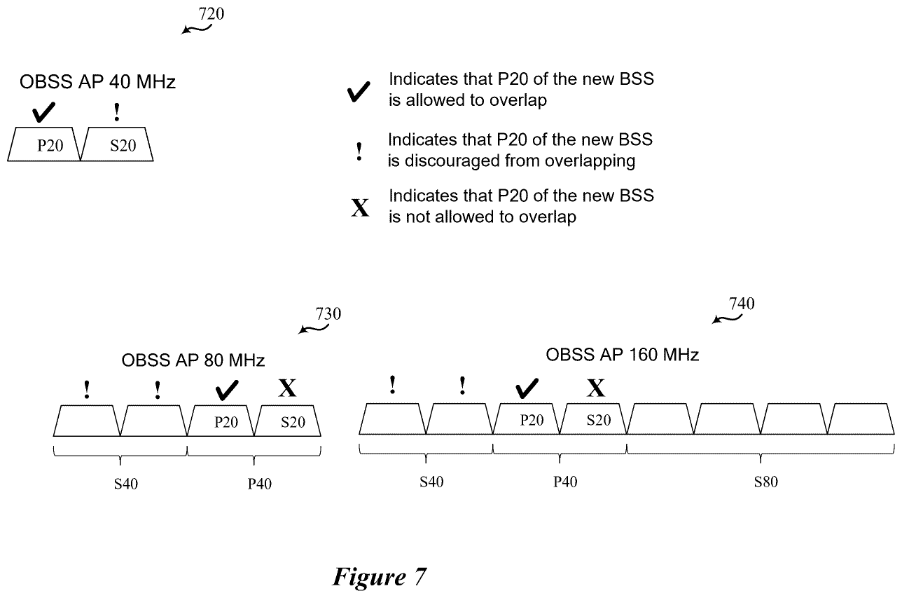

Application of these example rules for primary channel selection by a new BSS may be understood with reference to FIG. 6 and FIG. 7.

Referring first to FIG. 6, as illustrated at 610, the example illustrates how the P20 channel of a new 20 MHz BSS may be allowed to overlap with a P20 channel configured for an OBSS AP (as indicated by a check mark), while the P20 of the new BSS is discouraged from overlapping with an S20 channel of the OBSS (as indicated by the exclamation point). In this context, discourage may mean possibly allowed but not preferred (e.g., if another 20 MHz channel is available that does not overlap with an S20 channel of the OBSS that channel may be chosen over an overlapping 20 MHz channel). The P20 may be allowed to overlap with a P20 channel of a 40 MHz OBSS (as indicated at 620), with a P20 or P40 channel of an 80 MHz OBSS (as indicated at 630), or with a P20 or P40 channel of a 160 MHz OBSS (as indicated at 640).

Referring next to FIG. 7, the example illustrates how the P20 channel of a new 40 MHz (e.g., or higher bandwidth) BSS may be allowed to overlap with a P20 channel configured for an OBSS AP, while the P20 of the new BSS is not allowed to overlap with an S20 channel of the OBSS (as indicated by the “X”). The P20 may be allowed to overlap with a P20 channel of a 40 MHz OBSS (as indicated at 720), with a P20 or P40 channel of an 80 MHz OBSS (as indicated at 730), or with a P20 or P40 channel of a 160 MHz OBSS (as indicated at 740).

Aspects of the present disclosure propose techniques that may utilize certain rules to select opportunistic primary (O-Primary) channel(s). As described above, with multi-primary channel access, certain types of APs (e.g., ultra-high reliability or UHR APs) have more than one primary channel where they can contend for channel access.

Rules proposed herein may be applied by an AP forming a new BSS to select O-Primary channel(s), when existing BSS is also using multi-primary channel access. In other words, rules proposed herein may be used to select the operating bandwidth (and corresponding channel numbers) associated with O-Primary channel(s), as well as for selection of and channel access on secondary channels associated with O-Primary channel(s).

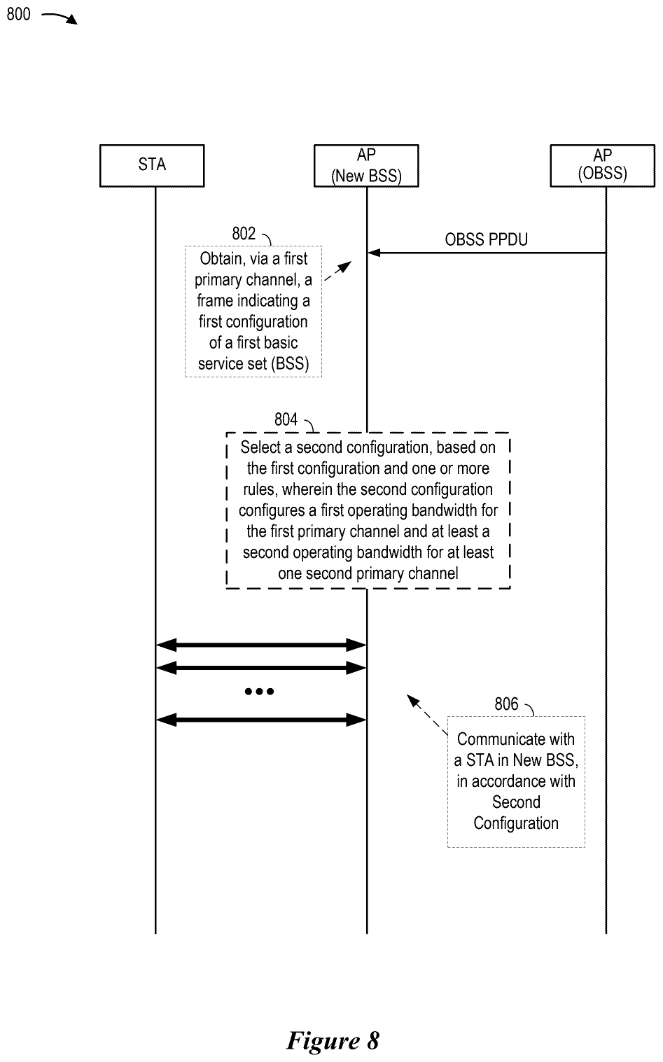

FIG. 8 depicts a call flow diagram 800 illustrating techniques for multi-primary channel selection, in accordance with certain aspects of the present disclosure. In some aspects, the APs shown in FIG. 8 may be examples of the AP 102 (e.g., an AP STA) depicted and described with respect to FIG. 1. In some aspects, the STA (e.g., a non-AP STA) shown in FIG. 8 may be an example of a STA 104 depicted and described with respect to FIG. 1.

As indicated at 802, an AP establishing a new BSS (the new AP) may obtain, via a first primary channel, a frame indicating a first configuration of a first BSS. For example, the new AP may detect a frame transmitted from an OBSS AP that indicates a bandwidth configuration indicating primary and opportunistic primary channel(s) selection for the OBSS AP. The frame may be a broadcast management frame, such as one or more of a beacon frame, probe response frame, or a fast initial link setup (FILS) discovery frame. The frame may also be a frame carrying a Neighbor Report element (e.g., a BTM Request frame) or a Reduced Neighbor Report element that is sent by a third AP.

As indicated at 804, the new AP may select a second configuration, based on the first configuration and one or more rules, wherein the second configuration configures the first primary channel and/or a first operating bandwidth for the first primary channel as well as at least one second primary channel and/or at least a second operating bandwidth for the at least one second primary channel. As indicated at 806, the new AP may communicate with a STA in a second BSS (the new BSS), in accordance with the second configuration.

The rules applied for multi-primary channel selection may be designed to optimize bandwidth configurations in certain ways. For example, one or more of the rules may be designed to achieve bandwidth configurations that allow multiple STAs to use the same channel for contention, by allowing the STAs to be able to detect each other using preamble detection and defer to each other's transmissions. The rules may also be designed to achieve bandwidth configurations that help mitigate the impact of adjacent channel interference in OBSSs.

According to certain aspects, rules proposed herein may extend and expand the primary channel selection rules described above. For example, the rules proposed herein for multi-primary channel selection may allow (main and/or opportunistic) primary channels of overlapping BSSs to be the same. One advantage of this approach is that it may allow all STAs to use the same (main and/or opportunistic) primary channel for contention. As a result, all STAs may be able to detect each other using preamble detection and may, thus, be able to defer to each other's PPDUs, thereby improving the reliability of transmissions in scenarios where multiple APs operate on overlapping bandwidths.

According to certain aspects, rules proposed herein may not allow (or at least may discourage) selection of primary channels that overlap with the secondary 20 MHz channel of an existing BSS. This may be preferred because, in some scenarios, adjacent channel interference between overlapping BSSs can hamper channel contention.

According to certain aspects, rules proposed herein may discourage selection of primary channels that overlap with the secondary 40 MHz channel of an existing BSS. This may be preferred because, in some scenarios (although fewer than the secondary 20 MHz channel case), adjacent channel interference between overlapping BSSs can hamper channel contention.

Techniques proposed herein may apply the aforementioned rules and rationale for the selection of O-primary channels. In some cases, rules described above (and with reference to FIGS. 6 and 7) may be applied for selection of a main 20 MHz primary (M-primary) channel, labeled as P20 in the figures. In addition, the following rules may be applied for selection of one or more O-Primary 20 MHz channels, labeled as O-P20 in the figures.

According to one example rule, selection of an O-Primary 20 MHz channel of a BSS that overlaps with an O-Primary 20 MHz of an OBSS may be allowed. In some cases, this type of selection may be encouraged (e.g., recommended in UHR) or required (e.g., to allow all STAs that have switched from an M-primary channel to use the same channel for contention).

According to another example rule, an O-Primary 20 MHz channel of a BSS may overlap with an (M-) Primary 20 MHz channel of an overlapping BSS. According to another example rule, an O-Primary 20 MHz channel of a BSS may not be allowed to overlap (or may be discouraged from overlapping) with S20 of an overlapping BSS. According to another example rule, an O-Primary 20 MHz channel of a BSS may not be allowed to overlap (e.g., or may be discouraged from overlapping) with O-S20 of an overlapping BSS.

According to another example rule, an O-Primary 20 MHz channel of a BSS may be discouraged from overlapping with (e.g., or may not be allowed to overlap with) an S40 channel of an overlapping BSS. According to another example rule, an O-Primary 20 MHz channel of a BSS may be discouraged from overlapping with (e.g., or may not be allowed to overlap with) with an O-S40 channel of an overlapping BSS.

According to certain aspects, whether a rule allows, encourages/discourages, or requires a certain selection may depend on various factors, such as the operating bandwidth (BW) of the BSS. For example, if the BW corresponding to each primary channel can be independently selected, the normative requirement may also be different based on the BW of the O-Primary channel. In some cases, when there is more than one O-Primary channel, the above rules may apply to selection of each O-Primary channel.

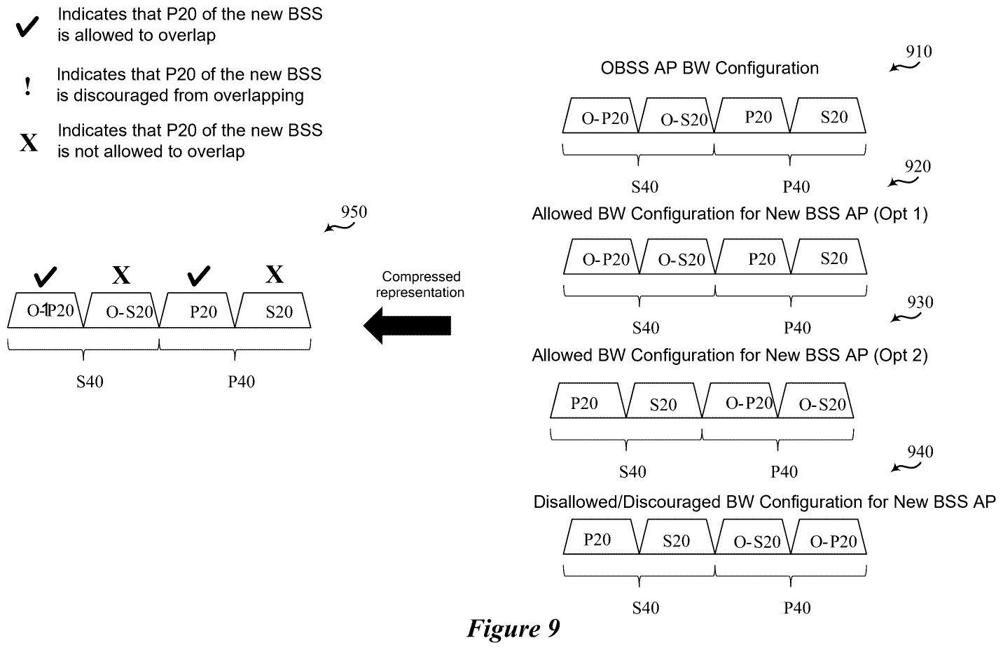

FIGS. 9-15 show examples of primary and secondary channel selection, in accordance with the rules described above.

Referring first to FIG. 9, the example assumes an 80 MHz OBSS AP with a BW configuration with P20, S20, O-P20, and O-S20 channels as shown at 910. A first example BW configuration for the new BSS AP is shown at 920, where the same types of channels overlap with the OBSS.

A second example BW configuration for the new BSS AP is shown at 930, where the main primary and secondary channels (P20 and S20) selected for the new BSS overlap with the opportunistic primary and secondary channels (O-P20 and O-S20) of the OBSS, while the O-P20 and O-S20 channels selected for the new BSS overlap with the P20 and S20 channels of the OBSS.

On the other hand, a disallowed/discouraged BW configuration for the new BSS AP is shown at 940. This BW configuration may be disallowed/discouraged, for example, because the O-P20 of the new BSS overlaps with the S20 of the OBSS and/or because the O-S20 of the new BSS overlaps with the B20 of the OBSS, either of which may hamper channel contention.

The allowed and disallowed/discouraged O-Primary channel selection depicted in FIG. 9 may be summarized (e.g., compressed) by the representation shown at 950. For example, in the compressed representation, a checkmark may indicate that the O-P20 of the new BSS is allowed/encouraged/required to overlap with the O-P20 or P20 of the OBSS, while the “X” may indicate that the O-P20 of the new BSS is discouraged/disallowed from overlapping with the O-S20 or S20 of the OBSS.

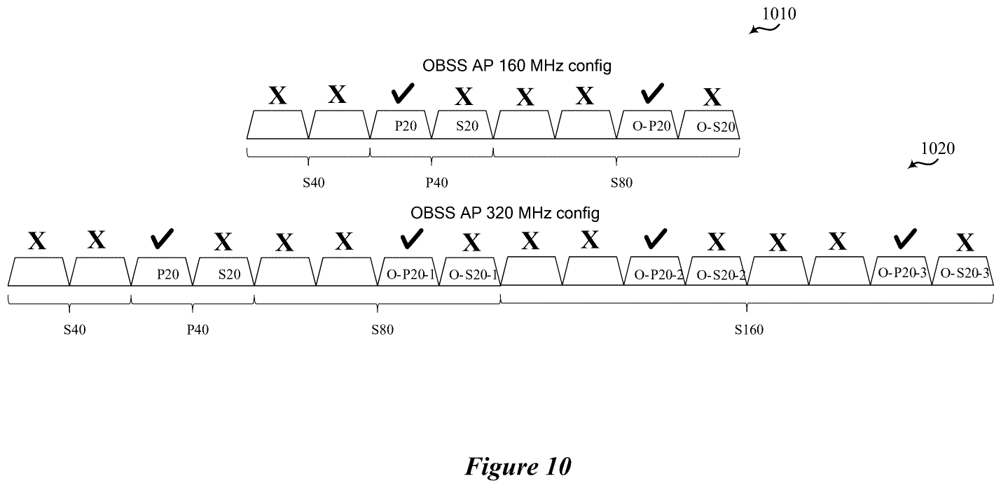

FIG. 10 illustrates how these same rules may be applied, based on BW configurations of a 160 MHz OBSS and a 320 MHz OBSS. As illustrated at 1010, a checkmark may indicate that the O-P20 of the new BSS is allowed/encouraged/required to overlap with the O-P20 or P20 of a 160 MHz OBSS, while the “X” indicates that the O-P20 of the new BSS is discouraged/disallowed from overlapping with any other type of channel of the 160 MHz OBSS. Similarly, as illustrated at 1020, a checkmark may indicate that the O-P20 of the new BSS is allowed/encouraged/required to overlap with any of multiple O-P20 channels (e.g., O-P20-1, O-P20-2, or O-P20-3) or P20 of a 320 MHz OBSS, while the “X” indicates that the O-P20 of the new BSS is discouraged/disallowed from overlapping with any other type of channel of the 320 MHz OBSS.

According to certain aspects, additional factors may be considered when selecting O-primary channels for a new BSS. For example, in some cases, if an existing overlapping BSS is 40 MHz and if the BSS is a legacy BSS (e.g., or if it does not support multi-primary channel operation), the new BSS may be able to select its O-P20 channel outside the OBSS channel BW.

In some cases, if a (e.g., UHR) BSS is 40 MHz wide, in order to support multi-primary channel access, the P20 and O-P20 channel may need to be adjacent 20 MHz channels. In other words, the S20 channel will be the same channel as the O-P20 channel. Similarly, the O-S20 channel will be the same as the P20 channel. As a result, the proposed channel selection rules proposed herein may not be satisfied.

There are various options to address such a scenario. For example, according to a first option (Option-1), multi-primary channel access may be disallowed for (e.g., UHR) BSSs that support only 40 MHz or operate at 40 MHz. According to a second option, multi-primary channel access may be allowed when (e.g., UHR) APs support only 40 MHz or operate at 40 MHz. However, in such cases, additional transmit power constraints may apply (e.g., to mitigate potential adjacent channel interference). Such transmit power constraints may be advertised by an AP, for example, in management frames (e.g., Beacons) sent on the M-Primary channel.

According to certain aspects, in addition to selecting the O-Primary channel(s), procedures may also be defined (e.g., in a wireless communication standard specification) to select the operating bandwidth associated with the O-Primary channels. In the context of this description, the term channel BW generally refers to the total BW that a main radio can operate on, the term primary BW generally refers to the BW associated with the M-Primary channel, and the term O-Primary BW generally refers to the BW associated with the O-Primary channel.

Aspects of the present disclosure propose various options for determining these various operating bandwidths.

For example, according to a first option, the operating bandwidth for each may be the same (e.g., O-Primary BW=Primary BW=Channel BW). In such cases, an AP may announce O-Primary channel locations only.

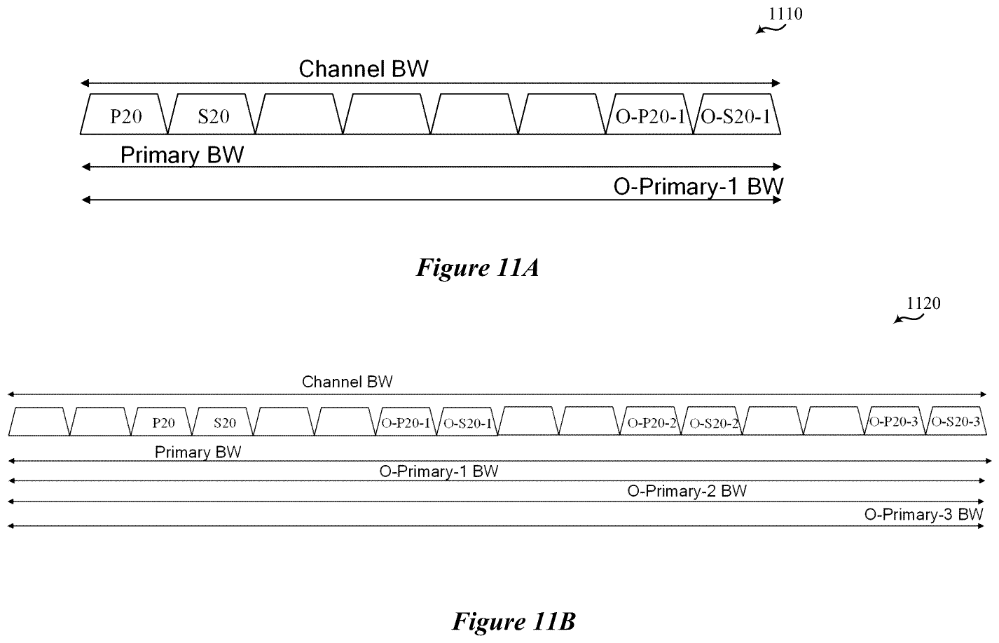

Diagrams 1110 of FIG. 11A and 1120 of FIG. 11B illustrate examples of this first option for a 160 MHz BSS and 320 MHz BSS, respectively. As illustrated, O-Primary 1 spans the Primary BW for the 160 MHz example, while O-Primary 1, O-Primary 2, and O-Primary 3 each span the Primary BW for the 320 MHz example. A potential advantage to this first option is that it may optimize (e.g., maximize) the gain of the multi-primary channel feature. This is because, as illustrated, access to any O-Primary channel may provide access to idle subchannels in the entire channel BW.

When operating with the BW configuration shown in Diagram 1110 of FIG. 11A, for example, a STA (e.g., an AP STA or non-AP STA or both) may transmit dynamically punctured PPDUs, wherein the STA does not transmit any energy in subchannels that are determined as busy when accessing a wide bandwidth after obtaining access on an O-Primary channel. In some aspects, the puncturing pattern may be indicated in a Universal SIG (U-SIG) field of the PPDU. In some cases, the BW signaled by the STA for the PPDU may be equal to the Primary BW. For example, if an AP operating with the BW configuration illustrated in Diagram 1110 determines P20 and S20 to be busy, the AP may contend for access on the O-P20-1 channel. Upon winning access to the medium on O-P20-1 (e.g., such as when a backoff counter associated with O-P20-1 counts down to zero), the AP may transmit a PPDU that spans the entire BW except P20 and S20. In some aspects, the AP may indicate that the PPDU bandwidth is 160 MHz, and the AP may further indicate in the puncturing pattern included in the U-SIG field of the PPDU that the subchannels corresponding to P20 and S20 are punctured. In some cases, the subchannel indication in the puncturing pattern may be in reference to the frequency range of the subchannels. For example, regardless of the location of the O-P20-1 channel, the bit position 0 in the bitmap may always correspond to the frequency-wise lowest 20 MHz subchannel within the operating bandwidth.

In some aspects, a STA (e.g., an AP STA or non-AP STA or both) may transmit multi-user (MU) PPDUs or Trigger Based (TB) PPDUs. The resource units (RUs) allocated to a STA may be contained in one or more subchannels, such as the subchannels illustrated in Diagram 1110. In some aspects, the STA may indicate the allocated RUs in a signal (SIG) field of the PPDU (e.g., an EHT SIG field or a UHR SIG field). In some aspects, the location of the allocated RUs within the frequency domain may be in reference to either P20 or the O-P20 (e.g., on which the transmitting STA won access to the medium). In some aspects, for example, the reference may be P20, while in other aspects, the reference may be O-P20-1. In some aspects, the reference may be specified in the PPDU (for example, in a SIG field of the PPPU).

According to certain aspects of the present disclosure, a STA (e.g., an AP STA or non-AP STA or both) may transmit a non-OFDMA PPDU. The available BW (e.g., such as BW that is idle) associated with the O-P20-1 channel may not be the same at the transmitting STA and the receiving STA. In some aspects, the transmitting STA and the receiving STA may perform a dynamic BW negotiation to determine the common BW that is available at the transmitter as well as the receiver. In some cases, the transmitting STA may need to specify the reference primary channel with respect to which the dynamic BW negotiation is performed. The location (e.g., index) of the primary channel with respect to which the dynamic BW negotiation is performed may be indicated in a field (e.g., a Service field) of the PPDU. The receiving STA may measure the available BW with respect to the primary channel specified in the received PPDU. The receiving STA may indicate the available BW within a field (e.g., a Service field) of a second PPDU sent in response to the PPDU. In some aspects, the reference primary channel may always be the M-Primary channel. In other aspects, the reference primary channel may be the O-Primary channel on which the transmitting STA won access.

According to a second option, the O-Primary BW may be less than the Primary BW and the Primary BW may be equal to the Channel BW (e.g., O-Primary BW<Primary BW=Channel BW). The BW of each O-Primary channel may be a subset of the Channel BW. In such cases, an AP may announce O-Primary channel locations and the O-Primary BW.

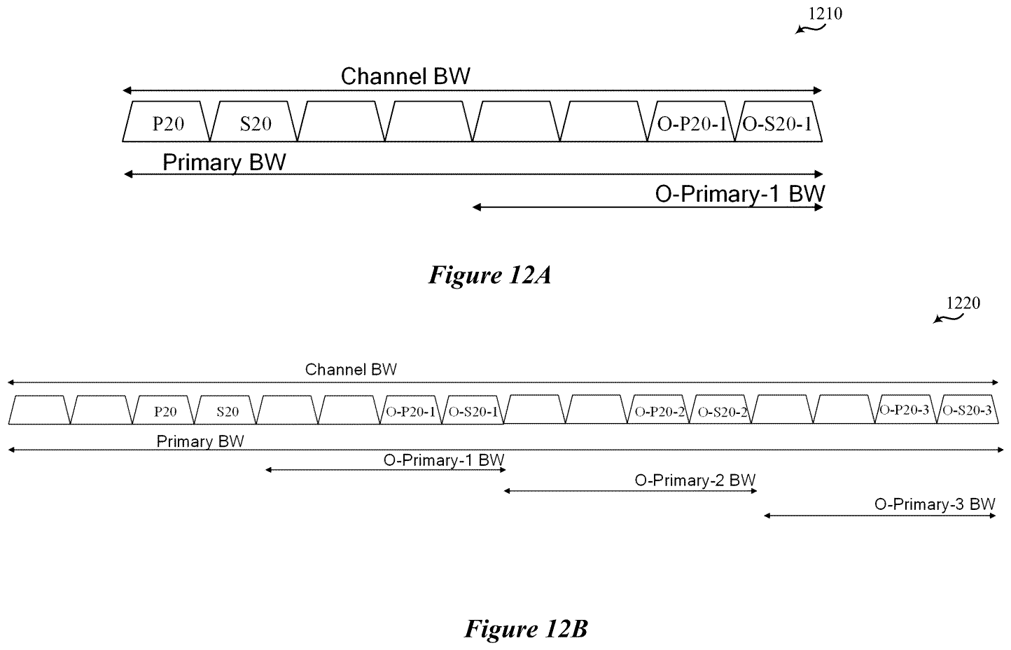

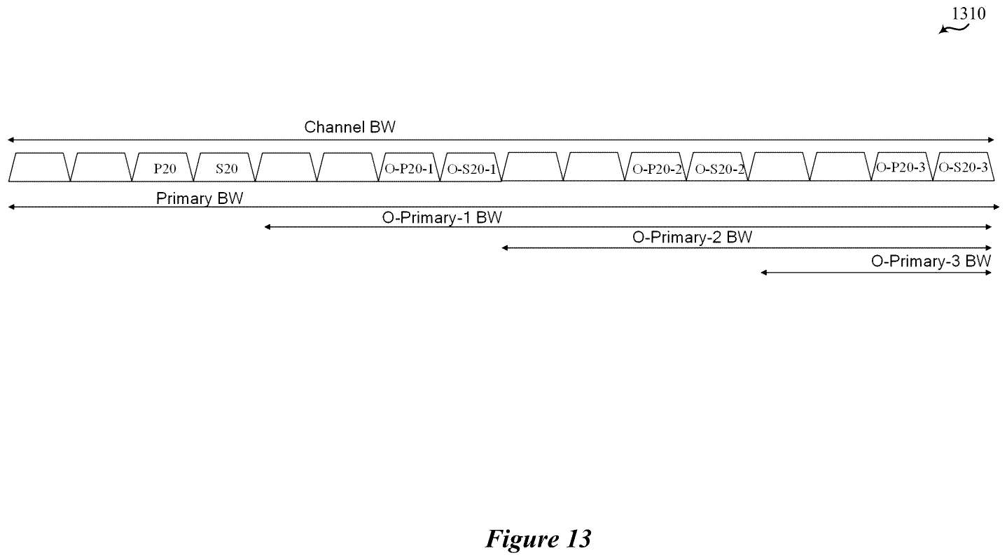

Diagrams 1210 of FIG. 12A and 1220 of FIG. 12B illustrate examples of this second option for a 160 MHz BSS and 320 MHz BSS, respectively. As illustrated, O-Primary 1 BW is less than the Primary BW for the 160 MHz example, while O-Primary 1, O-Primary 2, and O-Primary 3 BWs are each less the Primary BW for the 320 MHz example. Diagram 1310 of FIG. 13 illustrates another example of this second option for a 320 MHz BSS (in which O-Primary 3 BW<O-Primary 2 BW<O-Primary 1 BW). A potential advantage to this second option is that it may be considered simpler than the first option, although gains of the multi-primary channel feature may be less than the first option.

When operating with the BW configuration shown in Diagram 1210 of FIG. 12A, for example, a STA (e.g., an AP STA or non-AP STA or both) may transmit dynamically punctured PPDUs, wherein the STA does not transmit any energy in subchannels that are determined as busy when accessing a wide bandwidth after obtaining access on an O-Primary channel. In some aspects, the puncturing pattern may be indicated in a Universal SIG (U-SIG) field of the PPDU. In some cases, the BW signaled by the STA for the PPDU may be equal to the O-Primary BW. For example, if an AP operating with the BW configuration illustrated in Diagram 1210 determines P20 to be busy, the AP may contend for access on the O-P20-1 channel. Upon winning access to the medium on O-P20-1 (e.g., such as when a backoff counter associated with O-P20-1 counts down to zero), the AP may determine that the BW associated with O-S20-1 is busy and may transmit a PPDU that spans the O-Primary BW except O-S20-1. The AP may indicate that the PPDU bandwidth is 80 MHz, and the AP may further indicate in the puncturing pattern included in the U-SIG field of the PPDU that the subchannel corresponding to O-S20-1 is punctured. In some cases, the subchannel indication in the puncturing pattern may be in reference to the frequency range of the subchannels. For example, regardless of the location of the O-P20-1 channel, the bit position 0 in the bitmap may always correspond to the frequency-wise lowest 20 MHz subchannel within the O-Primary BW and/or the M-Primary BW.

In some aspects, a STA (e.g., an AP STA or non-AP STA or both) may transmit multi-user (MU) PPDUs or Trigger Based (TB) PPDUs. The resource units (RUs) allocated to a STA may be contained in one or more subchannels of the O-Primary-1 BW illustrated in Diagram 1210. In some aspects, the STA may indicate the allocated RUs in a signal (SIG) field of the PPDU (e.g., in an EHT SIG field or a UHR SIG field). In some aspects, the location of the allocated RUs within the frequency domain may be in reference to either P20 or the O-P20 on which the transmitting STA won access to the medium. In some aspects, for example, the reference may be P20, while in other aspects, the reference may be O-P20-1. In some aspects, the reference may be specified in the PPDU (e.g., in a SIG field of the PPPU).

In some aspects, a STA (e.g., an AP STA or non-AP STA or both) may transmit a non-OFDMA PPDU. The available BW (such as the BW that is idle) associated with the O-P20-1 channel may not be the same at the transmitting STA and the receiving STA. In some aspects, the transmitting STA and the receiving STA may perform a dynamic BW negotiation to determine the common BW that is available at the transmitter as well as the receiver. In some cases, the transmitting STA may need to specify the reference primary channel with respect to which the dynamic BW negotiation is performed. The location (e.g., index) of the primary channel with respect to which the dynamic BW negotiation is performed may be indicated in a field (e.g., a Service field) of the PPDU. The receiving STA may measure the available BW with respect to the primary channel specified in the received PPDU. The receiving STA may indicate the available BW within a field (e.g., a Service field) of a second PPDU sent in response to the PPDU. In some aspects, the reference primary channel may always be the M-Primary channel. In other aspects, the reference primary channel may be the O-Primary channel on which the transmitting STA won access.

According to a third option, each Primary channel BW may be a subset of the Chanel BW, while the sum of the Primary channel BWs may be equal to the Channel BW (e.g., O-Primary BW<Channel BW; Primary BW<Channel BW; Primary BW+O-Primary BW=Channel BW).

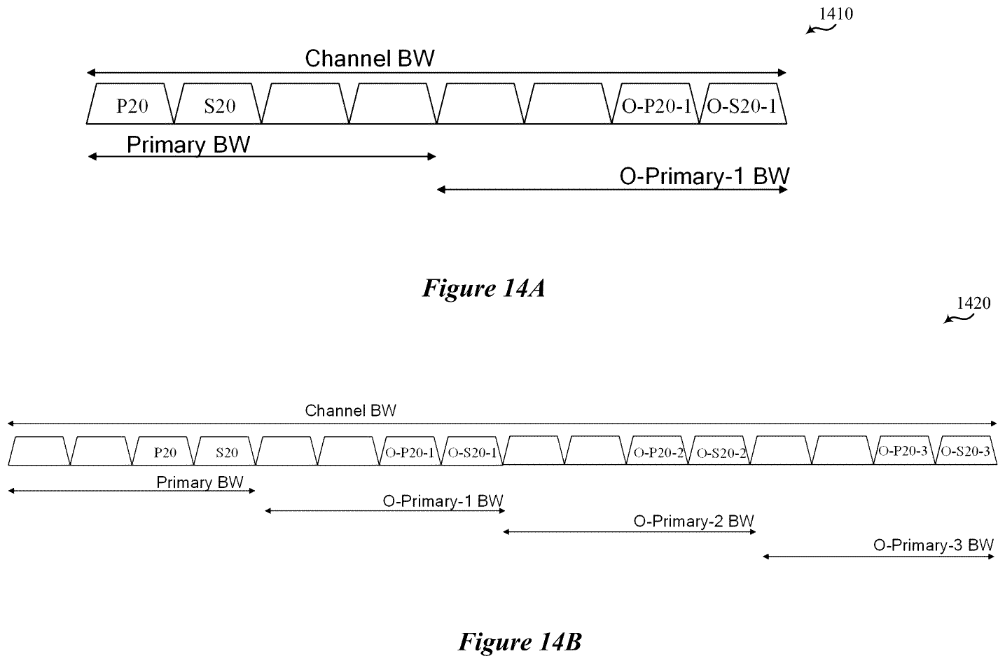

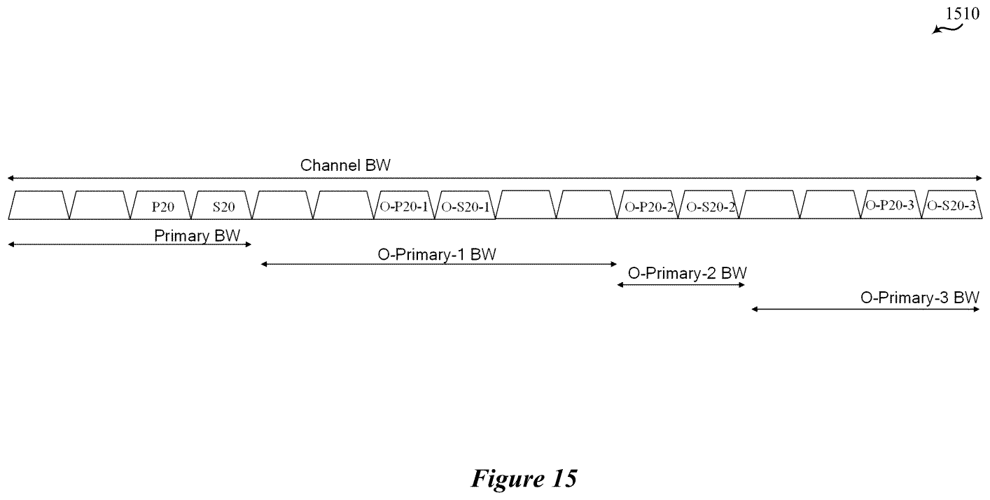

Diagrams 1410 of FIG. 14A and 1420 of FIG. 14B illustrate examples of this third option for a 160 MHz BSS and 320 MHz BSS, respectively. As illustrated, the Primary BW and O-Primary 1 BW are both less than the Channel BW, but together span the Channel BW for the 160 MHz example. Similarly, Primary, O-Primary 1, O-Primary 2, and O-Primary 3 BWs are each less the Channel BW, but span the Channel BW, for the 320 MHz example. Diagram 1510 of FIG. 15 illustrates another example of this third option for a 320 MHz BSS, in which the O-Primary channels may have different BWs. According to this third option, an AP may announce the O-Primary channel locations and the O-Primary BW. According to each of the example options described above, a transmitter ay use dynamic puncturing to utilize idle subchannels within O-Primary BW.

When operating with the BW configuration shown in Diagram 1410 of FIG. 14A, for example, a STA (e.g., an AP STA or non-AP STA or both) may transmit dynamically punctured PPDUs, wherein the STA does not transmit any energy in subchannels that are determined as busy when accessing a wide bandwidth after obtaining access on an O-Primary channel. In some aspects, the puncturing pattern may be indicated in a Universal SIG (U-SIG) field of the PPDU. In some cases, the BW signaled by the STA for the PPDU may be equal to the O-Primary BW. For example, if an AP operating with the BW configuration illustrated in Diagram 1410 determines P20 to be busy, the AP may contend for access on the O-P20-1 channel. Upon winning access to the medium on O-P20-1 (e.g., such as when a backoff counter associated with O-P20-1 counts down to zero), the AP may determine that the BW associated with O-S20-1 is busy and the AP may transmit a PPDU that spans the O-Primary BW except O-S20-1. The AP may indicate that the PPDU bandwidth is 80 MHz, and the AP may further indicate in the puncturing pattern included in the U-SIG field of the PPDU that the subchannel corresponding to O-S20-1 is punctured. In some cases, the subchannel indication in the puncturing pattern may be in reference to the frequency range of the subchannels. For example, regardless of the location of the O-P20-1 channel, the bit position 0 in the bitmap may always correspond to the frequency-wise lowest 20 MHz subchannel within the O-Primary BW.

In some aspects, a STA (e.g., an AP STA or non-AP STA or both) may transmit multi-user (MU) PPDUs or Trigger Based (TB) PPDUs. The resource units (RUs) allocated to a STA may be contained in one or more subchannels of the O-Primary-1 BW illustrated in Diagram 1410. In some aspects, the STA may indicate the allocated RUs in a signal (SIG) field of the PPDU (e.g., in an EHT SIG field or a UHR SIG field). In some aspects, the location of the allocated RUs within the frequency domain may be in reference to either P20 or the O-P20 on which the transmitting STA won access to the medium. In some aspects, for example, the reference may be P20, while in other aspects, the reference may be O-P20-1. In some aspects, the reference may be specified in the PPDU (for example, in a SIG field of the PPPU).

In some aspects, a STA (e.g., an AP STA or non-AP STA or both) may transmit a non-OFDMA PPDU. The available BW (such as the BW that is idle) associated with the O-P20-1 channel may not be the same at the transmitting STA and the receiving STA. In some aspects, the transmitting STA and the receiving STA may perform a dynamic BW negotiation to determine the common BW that is available at the transmitter as well as the receiver. In some cases, the transmitting STA may need to specify the reference primary channel with respect to which the dynamic BW negotiation is performed. The location (e.g., index) of the primary channel with respect to which the dynamic BW negotiation is performed may be indicated in a field (e.g., a Service field) of the PPDU. The receiving STA may measure the available BW with respect to the primary channel specified in the received PPDU. The receiving STA may indicate the available BW within a field (e.g., a Service field) of a second PPDU sent in response to the PPDU. In some aspects, the reference primary channel may always be the M-Primary channel. In other aspects, the reference primary channel may be the O-Primary channel on which the transmitting STA won access.

Aspects of the present disclosure may also provide rules that can be applied for the selection of secondary channels associated with O-Primary channels (O-Secondary channels). For example, as selection of a primary 20 MHz channel may automatically determine secondary 20, 40, 80, and 160 MHz channels (as described above and depicted in FIG. 3B), aspects of the present disclosure provide various options for selecting secondary channels when multiple primary channels are selected (e.g., in UHR AP BSSs).

According to a first option, multi-primary channel scenarios may utilize the same or similar rules as used for secondary channel selection in single primary channel scenarios. For example, an AP may announce O-Primary 20 MHz channel and O-Primary BW. The AP may also announce if an O-Secondary-20 channel is above or below the O-Primary-20 channel BW (e.g., via an O-Secondary Channel Offset subfield for O-Secondary in a UHR Operation element). Based on this information, STAs may be able to determine the O-Secondary 20, O-Secondary-40, O-Secondary-80, and the O-Secondary-160 (e.g., based on one or more rules or tables as described above).

According to a second option, all 20 MHz channels within the O-Primary BW, other than O-Primary-20, may be designated as O-secondary 20 MHz channels. In this case, the AP may announce the O-Primary 20 MHz channel and O-Primary BW. This may allow multi-primary channel capable STAs to perform a Point coordination function (PCF) Inter-frame Space (PIFS) energy detection (ED) check on all O-Secondary channels and transmit on the idle subchannels.

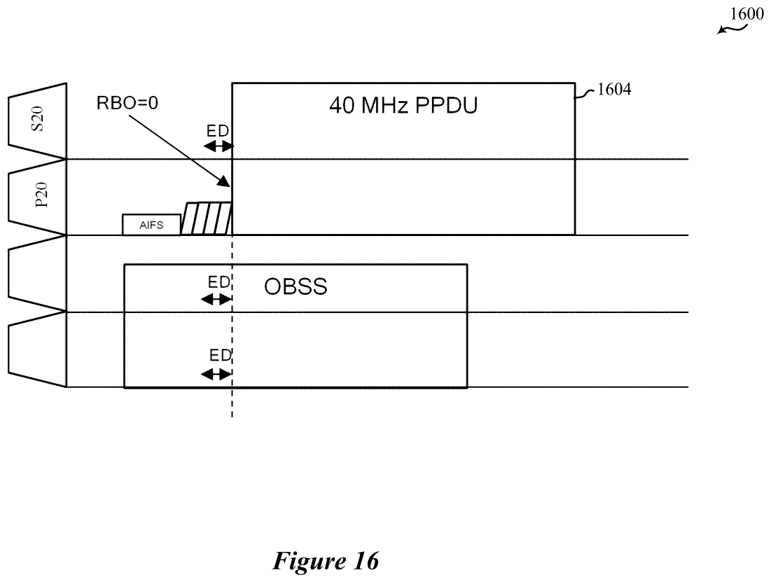

Aspects of the present disclosure may also provide rules that can be applied for channel access on secondary channels. As illustrated in diagram 1600 of FIG. 16, in single primary channel systems, for secondary channel access, a STA may perform an IFS plus random back off (RBO) on a primary 20 MHz channel (P20). The RBO may include preamble detection (PD) (−82 dBm) and ED (−62 dBm). For PIFS before the RBO counts down to 0, the STA may performs ED-only (−72 dBm) on secondary channels, in order to determine BW of channels.

According to aspects of the present disclosure, the same or similar rules may be applied on an M-Primary and secondary channels of an M-Primary.

According to certain aspects, when a STA wins access on an O-Primary 20 MHz channel (O-P20), it may perform ED (−72 dBm) on one or more O-Secondary channels. In some cases, as noted above, an M-Primary-20 may be one of the O-Secondary channels. In general, one of the (M/O)-Primary-20 channels may be the O-Secondary channel of the current O-Primary channel.

Aspects of the present disclosure provide various options for rules that may be applied to determine whether or not a STA can access a (M/O-) primary channel that was previously detected as busy using PD (and has an active NAV).

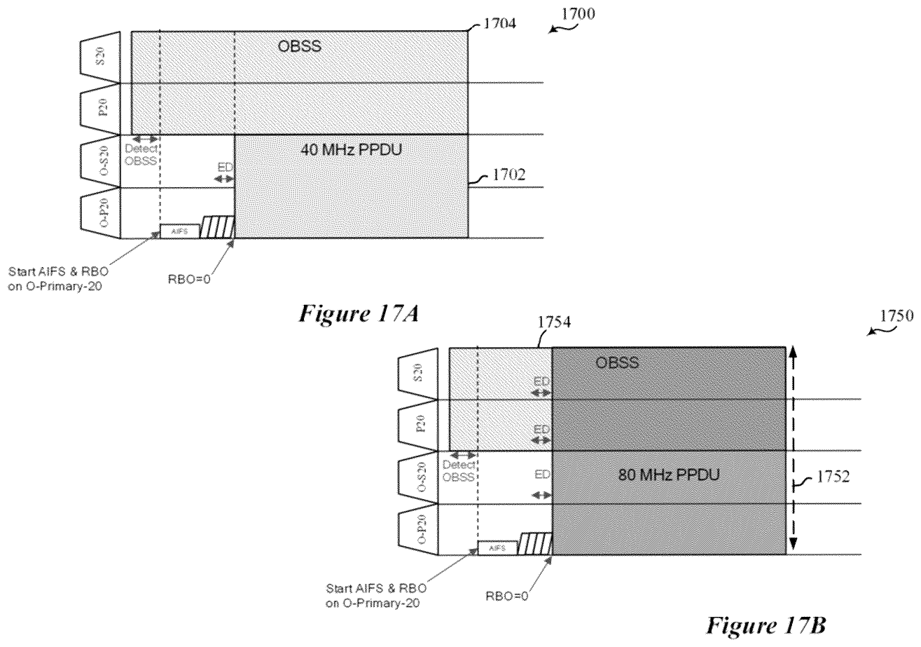

According to a first option, illustrated in diagram 1700 of FIG. 17A, the STA may not be allowed to perform ED (−72 dBm) on a primary channel that was previously detected as Busy. In the illustrated example, after detecting an OBSS transmission 1704 on P20, the STA may switch to an O-P20 to perform an IFS plus RBO, in order to participate in a 40 MHz PPDU 1702. For PIFS before the RBO counts down to 0, the STA may performs ED-only on O-S20, in order to determine BW. Because the STA was not allowed to perform ED on P20 that was previously found Busy, PPDU 1702 is limited to 40 MHz, as the other subchannels (P20 and S20) are not available.

According to a second option, illustrated in diagram 1750 of FIG. 17B a STA may be allowed to perform ED on a primary channel that was previously detected as Busy (e.g., P20 was detected in this example due to an OBSS transmission 1754). In this case, it is possible that the primary channel (e.g., previously detected as Busy) is now found idle because of the 10 dB difference between PD (−82 dBm) and ED (−72 dBm). As a result, the STA may be allowed to transmit on those subchannels (allowing for an 80 MHz PPDU as shown at 1752).

A third option may be considered a hybrid of the first and second options. According to this third option, a STA may not be allowed to perform ED on M-primary-20, but may be allowed to perform ED on an O-primary-20 channel that was previously found idle.

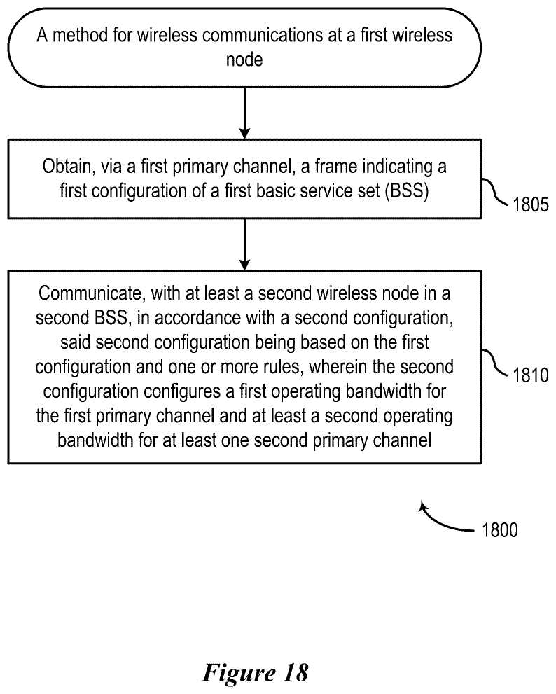

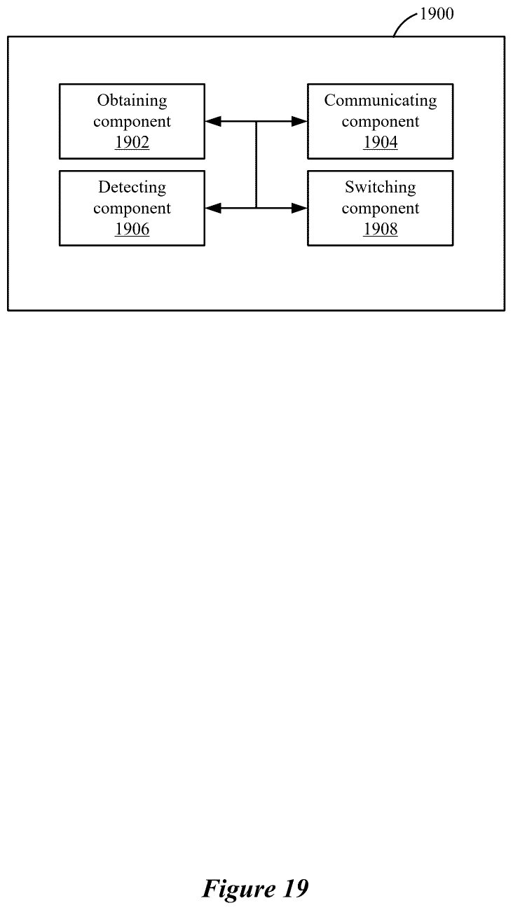

FIG. 18 shows a flowchart illustrating an example process 1800 performable at a first wireless node (e.g., an access point or a STA), according to certain aspects of the present disclosure. The operations of the process 1800 may be implemented by a wireless AP, or its components as described herein. For example, the process 1800 may be performed by a wireless communication device, such as the wireless communication device 1900 described with reference to FIG. 19, operating as or within a wireless AP. In some examples, the process 1800 may be performed by a wireless AP, such as one of the wireless APs 102 described with reference to FIG. 1.

Process 1800 begins at step 1805 with obtaining, via a first primary channel, a frame indicating a first configuration of a first basic service set (BSS).

Process 1800 then proceeds to step 1810 with communicating, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

In one aspect, process 1800, or any aspect related to it, may be performed by an apparatus, such as wireless communications device 1900 of FIG. 19, which includes various components operable, configured, or adapted to perform the process 1800. Wireless communications device 1900 is described below in further detail.

Note that FIG. 18 is just one example of a method, and other methods including fewer, additional, or alternative steps are possible consistent with this disclosure.

FIG. 19 shows a block diagram of an example wireless communication device 1900, according to some aspects of the present disclosure. In some aspects, the example wireless communication device 1900 is an example of a wireless node, such as an access point (AP) or a wireless station (STA). In one example, the wireless communication device 1900 is configured or operable to perform a process 1800, described with reference to FIG. 18. In various examples, the wireless communication device 1900 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1900 can be a device for use in an AP, such as AP 102 described with reference to FIG. 1. In some examples, the wireless communication device 1900 can be a device for use in a STA, such as STA 104 described with reference to FIG. 1. In some other examples, the wireless communication device 1900 can be an AP or a STA that includes such a chip, SoC, chipset, package or device as well as multiple antennas. The wireless communication device 1900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1900 also includes or can be coupled with an application processor which may be further coupled with another memory. In some examples, the wireless communication device 1900 further includes at least one external network interface that enables communication with a core network or backhaul network to gain access to external networks including the Internet.

The wireless communication device 1900 includes at least an obtaining component 1902, a communicating component 1904, a detecting component 1906, and a switching component 1908. Portions of one or more of the components 1902, 1904, 1906, and/or 1908 may be implemented at least in part in hardware or firmware. For example, the obtaining component 1902 may be implemented at least in part by a modem. In some examples, at least some of the components 1902, 1904, 1906, and/or 1908 are implemented at least in part by a processor and as software stored in a memory. For example, portions of one or more of the components 1902, 1904, 1906, and/or 1908 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1900). For example, a processing system of the wireless communication device 1900 may refer to a system including the various other components or subcomponents of the wireless communication device 1900, such as the processor, or a transceiver, or a communications manager, or other components or combinations of components of the wireless communication device 1900. The processing system of the wireless communication device 1900 may interface with other components of the wireless communication device 1900, and may process information received from other components (such as inputs or signals) or output information to other components. For example, a chip or modem of the wireless communication device 1900 may include a processing system, a first interface to output information and a second interface to obtain information. In some implementations, the first interface may refer to an interface between the processing system of the chip or modem and a transmitter, such that the wireless communication device 1900 may transmit information output from the chip or modem. In some implementations, the second interface may refer to an interface between the processing system of the chip or modem and a receiver, such that the wireless communication device 1900 may obtain information or signal inputs, and the information may be passed to the processing system. A person having ordinary skill in the art will readily recognize that the first interface also may obtain information or signal inputs, and the second interface also may output information or signal outputs.

### EXAMPLE CLAUSES

Implementation examples are described in the following numbered clauses:
Clause 1: A method for wireless communication at a first wireless node, comprising: obtaining, via a first primary channel, a frame indicating a first configuration of a first basic service set (BSS); and communicating, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.
Clause 2: The method of Clause 1, wherein: the first primary channel comprises a main primary channel; and the at least one second primary channel comprises an opportunistic primary channel.
Clause 3: The method of any one of Clauses 1-2, wherein the frame comprises: a beacon frame, a probe response frame, or a discovery frame.
Clause 4: The method of any one of Clauses 1-3, wherein the first configuration includes at least one of: a third operating bandwidth for the first primary channel; a fourth operating bandwidth for the at least one second primary channel; a fifth operating bandwidth for a first secondary channel; a sixth operating bandwidth for a second secondary channel; or a total bandwidth associated with the first BSS.
Clause 5: The method of any one of Clauses 1-4, wherein the communicating comprises: detecting, on the first primary channel, a PPDU associated with the first BSS; and switching, after detecting the PPDU, from the first primary channel to the at least one second primary channel so as to communicate with the second wireless node in the second BSS.
Clause 6: The method of Clause 5, further comprising: switching, after a network allocation vector (NAV) duration indicated via the PPDU, from the at least one second primary channel back to the first primary channel for communicating with the second wireless node in the second BSS.
Clause 7: The method of any one of Clauses 1-6, wherein the one or more rules dictate a status of the second operating bandwidth for the at least one second primary channel relative to one or more operating bandwidths of the first BSS.
Clause 8: The method of Clause 7, wherein the status indicates that the second operating bandwidth for the second primary channel is at least one of allowed, encouraged, required, discouraged, or disallowed from overlapping with one or more operating bandwidths of the first BSS.
Clause 9: The method of any one of Clauses 1-8, wherein the second configuration further configures at least one of: a third operating bandwidth for a first secondary channel; or a fourth operating bandwidth for a second secondary channel.
Clause 10: An apparatus, comprising: a memory comprising executable instructions; and a processor configured to execute the executable instructions and cause the apparatus to perform a method in accordance with any one of Clauses 1-9.
Clause 11: An apparatus, comprising means for performing a method in accordance with any one of Clauses 1-9.
Clause 12: A non-transitory computer-readable medium comprising executable instructions that, when executed by a processor of an apparatus, cause the apparatus to perform a method in accordance with any one of Clauses 1-9.
Clause 13: A computer program product embodied on a computer-readable storage medium comprising code for performing a method in accordance with any one of Clauses 1-9.
Clause 14: A wireless node (e.g., an access point) comprising: at least one transceiver; a memory comprising executable instructions; and one or more processors configured to execute the executable instructions and cause the apparatus to perform a method in accordance with any one of Clauses 1-9, wherein the at least one transceiver is configured to receive the frame.

### ADDITIONAL CONSIDERATIONS

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of”' a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for obtaining, means for communicating, means for detecting, and/or means for switching may comprise one or more processors, such as one or more of the processors described above with reference to FIG. 19.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors, individually or collectively, configured to execute the computer-executable instructions and cause the apparatus to:
obtain, via a first primary channel, a frame indicating a first configuration of a first basic service set (BSS); and
communicate, with at least one wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

2. The apparatus of claim 1, wherein:
the first primary channel comprises a main primary channel; and
the at least one second primary channel comprises an opportunistic primary channel.

3. The apparatus of claim 1, wherein the frame comprises: a beacon frame, a probe response frame, or a discovery frame.

4. The apparatus of claim 1, wherein the first configuration includes at least one of:
a third operating bandwidth for the first primary channel;
a fourth operating bandwidth for the at least one second primary channel;
a fifth operating bandwidth for a first secondary channel;
a sixth operating bandwidth for a second secondary channel; or
a total bandwidth associated with the first BSS.

5. The apparatus of claim 1, wherein in order to communicate, the one or more processors, individually or collectively, are further configured to cause the apparatus to:
detect, on the first primary channel, a PPDU associated with the first BSS; and
switch, after detection of the PPDU, from the first primary channel to the at least one second primary channel so as to communicate with the at least one wireless node in the second BSS.

6. The apparatus of claim 5, wherein the one or more processors, individually or collectively, are further configured to cause the apparatus to:
switch, after a network allocation vector (NAV) duration indicated via the PPDU, from the at least one second primary channel back to the first primary channel for communicating with the at least one wireless node in the second BSS.

7. The apparatus of claim 1, wherein the one or more rules dictate a status of the second operating bandwidth for the at least one second primary channel relative to one or more operating bandwidths of the first BSS.

8. The apparatus of claim 7, wherein the status indicates that the second operating bandwidth for the second primary channel is at least one of allowed, encouraged, required, discouraged, or disallowed from overlapping with one or more operating bandwidths of the first BSS.

9. The apparatus of claim 1, wherein the second configuration further configures at least one of:
a third operating bandwidth for a first secondary channel; or
a fourth operating bandwidth for a second secondary channel.

10. A method for wireless communication at a first wireless node, comprising:
obtaining, via a first primary channel, a frame indicating a first configuration of a first basic service set (BSS); and
communicating, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

11. The method of claim 10, wherein:
the first primary channel comprises a main primary channel; and
the at least one second primary channel comprises an opportunistic primary channel.

12. The method of claim 10, wherein the frame comprises: a beacon frame, a probe response frame, or a discovery frame.

13. The method of claim 10, wherein the first configuration includes at least one of:
a third operating bandwidth for the first primary channel;
a fourth operating bandwidth for the at least one second primary channel;
a fifth operating bandwidth for a first secondary channel;
a sixth operating bandwidth for a second secondary channel; or
a total bandwidth associated with the first BSS.

14. The method of claim 10, wherein the communicating comprises:
detecting, on the first primary channel, a PPDU associated with the first BSS; and
switching, after detecting the PPDU, from the first primary channel to the at least one second primary channel so as to communicate with the second wireless node in the second BSS.

15. The method of claim 14, further comprising:
switching, after a network allocation vector (NAV) duration indicated via the PPDU, from the at least one second primary channel back to the first primary channel for communicating with the second wireless node in the second BSS.

16. The method of claim 10, wherein the one or more rules dictate a status of the second operating bandwidth for the at least one second primary channel relative to one or more operating bandwidths of the first BSS.

17. The method of claim 16, wherein the status indicates that the second operating bandwidth for the second primary channel is at least one of allowed, encouraged, required, discouraged, or disallowed from overlapping with one or more operating bandwidths of the first BSS.

18. The method of claim 10, wherein the second configuration further configures at least one of:
a third operating bandwidth for a first secondary channel; or
a fourth operating bandwidth for a second secondary channel.

19. An access point (AP), comprising:
at least one transceiver; at least one memory comprising executable instructions; and one or more processors, individually or collectively, configured to execute the executable instructions and cause the AP to:
receive, via the at least transceiver on a first primary channel, a frame indicating a first configuration of a first basic service set (BSS); and
communicate, with at least a second wireless node in a second BSS, in accordance with a second configuration, said second configuration being based on the first configuration and one or more rules, wherein the second configuration configures a first operating bandwidth for the first primary channel and at least a second operating bandwidth for at least one second primary channel.

20. The AP of claim 19, wherein in order to communicate, the one or more processors, individually or collectively, are further configured to cause the AP to:
detect, on the first primary channel, a PPDU associated with the first BSS; and
switch, after detection of the PPDU, from the first primary channel to the at least one second primary channel so as to communicate with the second wireless node in the second BSS.
